(19) United States
(12) Patent Application Publication
(10) Pub. No.: US 2026/0052575 A1
(43) Pub. Date: Feb. 19, 2026

(54) OPPORTUNISTIC MULTIPLE RANDOM ACCESS CHANNEL (RACH) TRANSMISSIONS USING RACH OCCASIONS IN SUBBAND FULL DUPLEX SLOTS

(71) Applicant: QUALCOMM Incorporated, San Diego, CA (US)

(72) Inventors: Ahmed Attia ABOTABL, San Diego, CA (US); Muhammad Sayed Khairy ABDELGHAFFAR, San Jose, CA (US); Abdelrahman Mohamed Ahmed Mohamed IBRAHIM, San Diego, CA (US); Hung Dinh LY, San Diego, CA (US)

(21) Appl. No.: 18/805,129

(22) Filed: Aug. 14, 2024

(51) Int. Cl. H04W 74/0833; H04L 5/14; H04W 74/00

(52) U.S. Cl. CPC H04W 74/0833; H04L 5/14; H04W 74/002

(57) ABSTRACT

Methods, systems, and devices for wireless communications are described. A user equipment (UE) may receive control information that indicates a first set of random access channel (RACH) occasions (ROs) scheduled during subband full duplex (SBFD) slots and a second set of ROs scheduled during non-SBFD slots. The UE may perform an RO validation procedure to determine a set of consecutive valid ROs for transmission of a RACH message. The set of consecutive valid ROs may include one or more of the first set of ROs, one or more of the second set of ROs, or both, and may be determined through the RO validation procedure in accordance with a rule that defines how the first set of ROs is used for transmission of RACH repetitions. The UE may transmit, over the set of consecutive valid ROs, repetitions of the RACH message in accordance with the RO validation procedure.

### FIELD OF TECHNOLOGY

The following relates to wireless communications, including opportunistic multiple random access channel (RACH) transmissions using RACH occasions (ROs) in subband full duplex (SBFD) slots.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving control information that indicates a first set of random access channel (RACH) occasions (ROs) scheduled during subband full duplex (SBFD) slots and a second set of ROs scheduled during non SBFD slots, performing a RO validation procedure to determine a set of consecutive valid ROs for transmission of a RACH message, where the set of consecutive valid ROs includes one or more of the first set of ROs, one or more of the second set of ROs, or both, and where the set of consecutive valid ROs is determined through the RO validation procedure in accordance with a rule that defines how the first set of ROs is used for transmission of RACH repetitions, and transmitting, over the set of consecutive valid ROs, repetitions of the RACH message in accordance with the RO validation procedure.

A UE for wireless communications is described. The UE may include one or more memories storing processor executable code, and one or more processors coupled with the one or more memories. The one or more processors may individually or collectively be operable to execute the code to cause the UE to receive control information that indicates a first set of ROs scheduled during SBFD slots and a second set of ROs scheduled during non SBFD slots, perform a RO validation procedure to determine a set of consecutive valid ROs for transmission of a RACH message, where the set of consecutive valid ROs includes one or more of the first set of ROs, one or more of the second set of ROs, or both, and where the set of consecutive valid ROs is determined through the RO validation procedure in accordance with a rule that defines how the first set of ROs is used for transmission of RACH repetitions, and transmit, over the set of consecutive valid ROs, repetitions of the RACH message in accordance with the RO validation procedure.

Another UE for wireless communications is described. The UE may include means for receiving control information that indicates a first set of ROs scheduled during SBFD slots and a second set of ROs scheduled during non SBFD slots, means for performing a RO validation procedure to determine a set of consecutive valid ROs for transmission of a RACH message, where the set of consecutive valid ROs includes one or more of the first set of ROs, one or more of the second set of ROs, or both, and where the set of consecutive valid ROs is determined through the RO validation procedure in accordance with a rule that defines how the first set of ROs is used for transmission of RACH repetitions, and means for transmitting, over the set of consecutive valid ROs, repetitions of the RACH message in accordance with the RO validation procedure.

A non-transitory computer-readable medium storing code for wireless communications is described. The code may include instructions executable by one or more processors to receive control information that indicates a first set of ROs scheduled during SBFD slots and a second set of ROs scheduled during non SBFD slots, perform a RO validation procedure to determine a set of consecutive valid ROs for transmission of a RACH message, where the set of consecutive valid ROs includes one or more of the first set of ROs, one or more of the second set of ROs, or both, and where the set of consecutive valid ROs is determined through the RO validation procedure in accordance with a rule that defines how the first set of ROs is used for transmission of RACH repetitions, and transmit, over the set of consecutive valid ROs, repetitions of the RACH message in accordance with the RO validation procedure.

In some examples of the method, UEs, and non-transitory computer-readable medium described herein, the set of consecutive valid ROs may be determined through the RO validation procedure based on a configured quantity of RACH repetitions that each use a same frequency resource and a rule-based time duration of the set of consecutive valid ROs may be based on a legacy time duration that includes the configured quantity of RACH repetitions associated with only the second set of ROs.

In some examples of the method, UEs, and non-transitory computer-readable medium described herein, the set of consecutive valid ROs includes one or more of the second set of ROs and does not include any of the first set ROs based on the rule defining that the set of consecutive valid ROs may be selected from only the second set of ROs.

In some examples of the method, UEs, and non-transitory computer-readable medium described herein, the set of consecutive valid ROs includes one or more of the first set of ROs and one or more of the second set of ROs based on the rule defining that the set of consecutive valid ROs may be selected from individual ones of the first set of ROs that may be associated with a same preamble mapping as individual ones of the second set of ROs.

In some examples of the method, UEs, and non-transitory computer-readable medium described herein, the rule-based time duration of the set of consecutive valid ROs may be equal to the legacy time duration and an actual quantity of the set of consecutive valid ROs may be greater than the configured quantity of RACH repetitions.

In some examples of the method, UEs, and non-transitory computer-readable medium described herein, the rule-based time duration of the set of consecutive valid ROs may be less than the legacy time duration and an actual quantity of the set of consecutive valid ROs may be equal to the configured quantity of RACH repetitions.

In some examples of the method, UEs, and non-transitory computer-readable medium described herein, the rule-based time duration of the set of consecutive valid ROs may be less than the legacy time duration and an actual quantity of the set of consecutive valid ROs may be greater than the configured quantity of RACH repetitions.

In some examples of the method, UEs, and non-transitory computer-readable medium described herein, the set of consecutive valid ROs includes one or more of the first set of ROs and one or more of the second set of ROs based on the rule defining that the set of consecutive valid ROs includes individual ones of the first set of ROs only if the individual ones of the first set of ROs may be temporally after a starting RO of the second set of ROs and before a last RO of the second set of ROs during the legacy time duration.

In some examples of the method, UEs, and non-transitory computer-readable medium described herein, the set of consecutive valid ROs includes one or more of the first set of ROs and one or more of the second set of ROs based on the rule defining that the set of consecutive valid ROs includes individual ones of the first set of ROs that may be within a threshold quantity of symbols or slots after a last RO of the second set of ROs during the legacy time duration.

Some examples of the method, UEs, and non-transitory computer-readable medium described herein may further include operations, features, means, or instructions for receiving a control message that indicates the threshold quantity.

In some examples of the method, UEs, and non-transitory computer-readable medium described herein, the set of consecutive valid ROs includes one or more of the second set of ROs and does not include any of the first set of ROs based on the rule defining that the set of consecutive valid ROs may be selected from only the second set of ROs as long as a first latency threshold may be satisfied and an actual quantity of the set of consecutive valid ROs may be equal to or greater than the configured quantity of RACH repetitions.

In some examples of the method, UEs, and non-transitory computer-readable medium described herein, the set of consecutive valid ROs includes one or more of the first set of ROs and one or more of the second set of ROs based on the rule defining that the set of consecutive valid ROs may be selected from both the first set of ROs and the second set of ROs if selection from only the second set of ROs results in a first latency threshold not being satisfied and an actual quantity of the set of consecutive valid ROs may be equal to or greater than the configured quantity of RACH repetitions.

In some examples of the method, UEs, and non-transitory computer-readable medium described herein, the set of consecutive valid ROs includes one or more of the second set of ROs and does not include any of the first set of ROs based on the rule defining that the set of consecutive valid ROs may be selected from only the second set of ROs and that an actual quantity of the set of consecutive valid ROs may be greater than the configured quantity of RACH repetitions if selection from only the second set of ROs for only the configured quantity of RACH repetitions results in a first latency threshold not being satisfied.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports opportunistic multiple random access channel (RACH) transmissions using RACH occasions (ROs) in subband full duplex (SBFD) slots in accordance with one or more aspects of the present disclosure.

FIG. 2 shows an example of a wireless communications that supports opportunistic multiple RACH transmissions using ROs in SBFD slots in accordance with one or more aspects of the present disclosure.

FIG. 3 shows an example of a RO validation procedure that supports opportunistic multiple RACH transmissions using ROs in SBFD slots in accordance with one or more aspects of the present disclosure.

FIG. 4 shows an example of a process flow that supports opportunistic multiple RACH transmissions using ROs in SBFD slots in accordance with one or more aspects of the present disclosure.

FIGS. 5 and 6 show block diagrams of devices that support opportunistic multiple RACH transmissions using ROs in SBFD slots in accordance with one or more aspects of the present disclosure.

FIG. 7 shows a block diagram of a communications manager that supports opportunistic multiple RACH transmissions using ROs in SBFD slots in accordance with one or more aspects of the present disclosure.

FIG. 8 shows a diagram of a system including a device that supports opportunistic multiple RACH transmissions using ROs in SBFD slots in accordance with one or more aspects of the present disclosure.

FIG. 9 shows a flowchart illustrating methods that support opportunistic multiple RACH transmissions using ROs in SBFD slots in accordance with one or more aspects of the present disclosure.

### DETAILED DESCRIPTION

In some examples of wireless communications, a user equipment (UE) and a network entity may operate in accordance with random access procedures. For instance, random access may allow the UE to establish a connection with the network entity (such as initial access to the network entity 105-a or during mobility events of the UE). In some examples, a random access channel (RACH) procedure involves a set of steps where the UE transmits a RACH message (e.g., a physical RACH (PRACH) preamble), receives a response from the network entity, and completes the process to establish a connection. In some examples, the UE may determine to transmit a RACH message (e.g., a PRACH preamble) with repetition over set of consecutive occasions (e.g., RACH occasions (ROs)). For example, the network entity may configure the UE with an RO group which includes a set of ROs, over which the UE may transmit repetitions of the RACH message. In some examples, the network entity may configure a first set of ROs over uplink dedicated time slots (e.g., legacy ROs). Additionally, or alternatively, the network entity may configure the UE with a second set of ROs during uplink resources of subband full duplex (SBFD) slots (e.g., SBFD ROS). As such, if the UE is SBFD-aware (e.g., capable of communication during SBFD slots) it may be advantageous for the UE to utilize ROs scheduled for SBFD slots in accordance with performing RACH procedures.

According to the techniques described herein, the UE may perform an RO validation procedure to determine a set of consecutive valid ROs for transmission of a RACH message with repetition. For example, the network entity may configure the UE with a legacy RO group that includes a set of non-SBFD ROs, where the legacy RO group spans a legacy time duration. Additionally, the network entity may configure the UE with one or more SBFD ROs. As such, in accordance with the RO validation procedure, the UE may determine whether to opportunistically transmit repetition of the RACH message during the one or more SBFD ROs based on whether the SBFD ROS are associated with a same set of frequency resources as the non-SBFD ROs. Additionally, or alternatively, the UE may determine whether to opportunistically transmit repetition of the RACH message during the one or more SBFD ROs based on whether transmitting during the SBFD ROs would increase or decrease the legacy time duration associated with the legacy RO group.

For instance, if the UE is configured with four non-SBFD ROs that form a legacy RO group, and configured with one SBFD RO that has a same preamble mapping as the non-SBFD ROs and falls after the first non-SBFD RO but before the last non-SBFD RO of the legacy RO group, then the UE may determine to transmit a repetition of the PRACH preamble during the SBFD RO. In some examples, the UE may transmit a PRACH preamble repetition during the SBFD RO and drop the last non-SBFD RO of the legacy RO group to reduce latency of the RACH transmission. In some examples, the UE may transmit a repetition of the PRACH preamble during the SBFD RO in addition to a repetition during each non-SBFD RO of the legacy RO group to increase the reliability of the RACH transmission.

Aspects of the disclosure are initially described in the context of wireless communications systems, a RO validation procedure, and a process flow. Aspects of the disclosure are further illustrated by and described with reference to apparatus diagrams, system diagrams, and flowcharts that relate to opportunistic multiple RACH transmissions using ROs in SBFD slots.

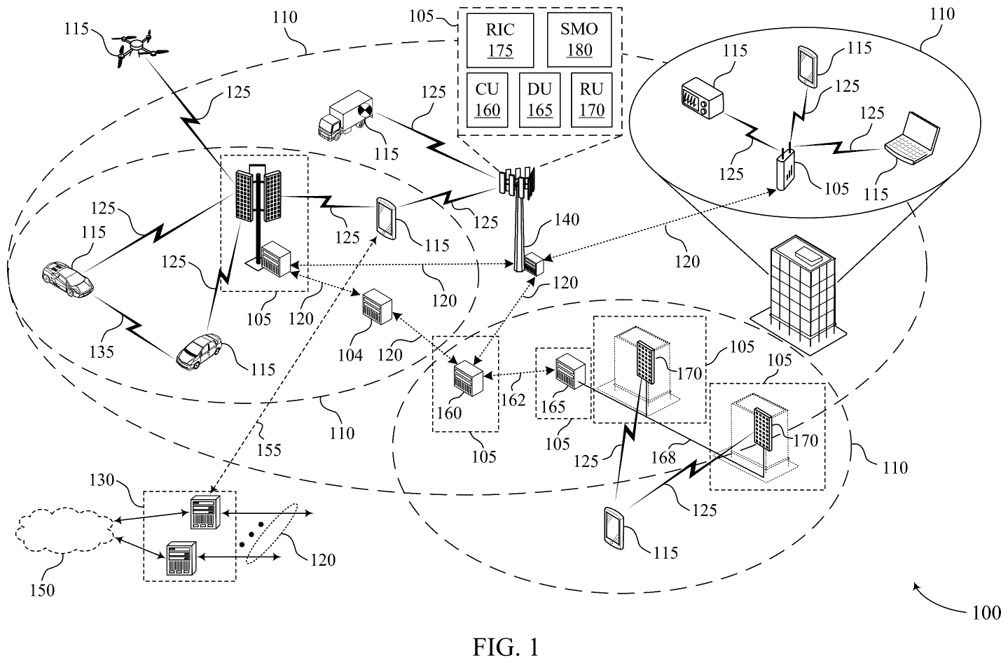

FIG. 1 shows an example of a wireless communications system 100 that supports opportunistic multiple RACH transmissions using ROs in SBFD slots in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (CNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1: M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

### ADD BRIEF DESCRIPTION OF THE INVENTION

In some examples of wireless communications system 100, a UE 115 may perform an RO validation procedure to determine a set of consecutive valid ROs for transmission of a RACH message with repetition. For example, the network entity 105 may configure the UE 115 with a legacy RO group that includes a set of non-SBFD ROs, where the legacy RO group spans a legacy time duration. Additionally, the network entity 105 may configure the UE 115 with one or more SBFD ROs. As such, in accordance with the RO validation procedure, the UE 115 may determine whether to opportunistically transmit repetition of the RACH message during the one or more SBFD ROs based on whether the SBFD ROs are associated with a same set of frequency resources as the non-SBFD ROs. Additionally, or alternatively, the UE 115 may determine whether to opportunistically transmit repetition of the RACH message during the one or more SBFD ROs based on whether transmitting during the SBFD ROS would increase or decrease the legacy time duration associated with the legacy RO group.

For instance, if the UE 115 is configured with four non-SBFD ROs that form a legacy RO group, and configured with one SBFD RO that has a same preamble mapping as the non-SBFD ROs and falls after the first non-SBFD RO but before the last non-SBFD RO of the legacy RO group, then the UE 115 may determine to transmit a repetition of the PRACH preamble during the SBFD RO. In some examples, the UE 115 may transmit a PRACH preamble repetition during the SBFD RO and drop the last non-SBFD RO of the legacy RO group to reduce latency of the RACH transmission. In some examples, the UE 115 may transmit a repetition of the PRACH preamble during the SBFD RO in addition to a repetition during each non-SBFD RO of the legacy RO group to increase the reliability of the RACH transmission.

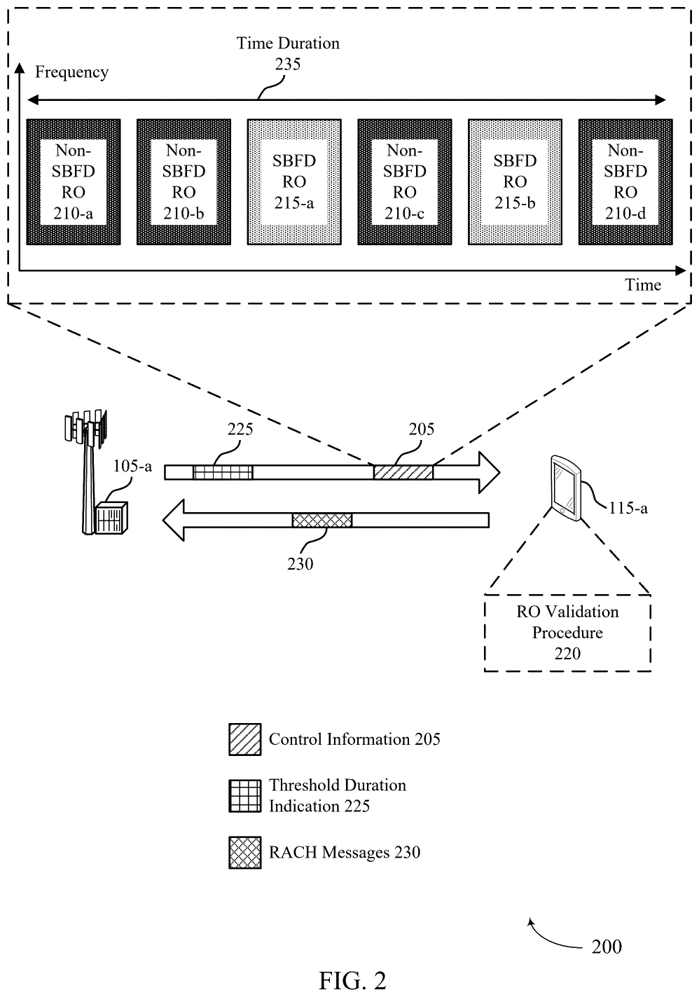

FIG. 2 shows an example of a wireless communications system 200 that supports opportunistic multiple RACH transmissions using ROs in SBFD slots in accordance with one or more aspects of the present disclosure. The wireless communications system 200 may implement or may be implemented by aspects of the wireless communications system 100. For example, the wireless communications system 200 may include a UE 115-a and a network entity 105-a, which may be respective examples of a UE 115 and a network entity 105 as described with reference to FIG. 1.

In some examples of wireless communications system 200, the UE 115-a and network entity 105-a may operate in accordance with random access procedures. For instance, RACH based operation may be a component of performing initial access, handover, and uplink synchronization between the UE 115-a and the network entity 105-a. In some examples, random access may allow the UE 115-a to establish a connection with the network entity 105-a (such as initial access to the network entity 105-a or during mobility events). In some examples, a RACH procedure involves a set of steps where the UE 115-a transmits a RACH message (e.g., a PRACH preamble), receives a response from the network entity 105-a, and completes the process to establish a connection. A RACH procedure may be performed in accordance with contention-based access, in accordance with contention free access, or both. For instance, for contention-based access, multiple UEs 115 serviced by the network entity 105-a may use a same PRACH preamble. In cases where concurrent transmission of a same PRACH preamble from respective UEs 115 results in a collision, the multiple UEs 115 may use a contention resolution mechanism to select different PRACH preambles. In accordance with contention-free access, the UE 115-a may receive from the network entity 105-a a dedicated PRACH preamble for one or more different types of random-access scenarios (e.g., handover). As such, the UE-specific PRACH preamble may reduce the occurrence of PRACH preamble collisions with transmissions from other wireless devices.

In some examples, a PRACH procedure for the UE 115-a may be triggered upon request of a PRACH transmission by higher layers (e.g., RRC) or by a physical downlink control channel (PDCCH) order associated with a cell of the network entity 105-a. A configuration by higher layers for a PRACH transmission may include one or more of a configuration for PRACH transmission on the cell, a preamble index, a preamble SCS, a transmission power (P_{PRACH,target}), a corresponding random access radio network temporary identifier (RA-RNTI), and a PRACH resource for the cell. In some examples, the configuration by higher layers may additionally include a quantity of PRACH preamble repetitions

$$( e . g . , {N}_{preamble}^{rep} > 1 )$$

for the PRACH transmission if the UE 115-a is configured to transmit the PRACH with repetitions.

In some examples, the UE 115-a may transmit a PRACH on a cell in accordance with the selected PRACH format with a transmission power of P_{PRACH,b,f,c}(i) on the indicated PRACH resource or on a determined set of

$${N}_{preamble}^{rep}$$

resources in accordance with a same spatial filter in a case of

$${N}_{preamble}^{rep}$$

preamble repetitions. For a PRACH transmission with

$${N}_{preamble}^{rep}$$

preamble repetitions, a set may consist of

$${N}_{preamble}^{rep}$$

valid ROs that may be consecutive in time, use same frequency resources, and are associated with a same one or more synchronization signal (SS) or physical broadcast channel (PBCH) block indexes. Additionally, or alternatively, each SS or PBCH block index may be associated with the same preamble indexes in each valid RO within the set of ROs. For a PRACH transmission with preamble repetitions, a time period, starting from frame 0, may be a smallest integer number of association pattern periods such that at least one set of valid ROs for each of the

$${N}_{Tx}^{SSB}$$

SS or PBCH block indexes may be determined within the time period for each configured number of preamble repetitions. In some examples, the one or more sets of valid ROs for each configured number of preamble repetitions may repeat for each time period.

In some examples, a set of ROs may be associated with an RO group. For instance, an RO group may be a set of

$${N}_{preamble}^{rep}$$

valid ROs that are consecutive in time and use a same set of frequency resources. In one example, the UE 115-a may be configured with two RO groups that each respectively include four consecutive ROs that are frequency division multiplexed (FDMed) for a PRACH preamble with repetition (e.g., N=4), and the UE 115-a may be additionally associated with a synchronization signal block (SSB) (e.g., SSB #0). As such, a first RO group of the two RO groups may span a first set of frequency resources for SSB #0 and the second RO group of the two RO groups may span a second set of frequency resources for SSB #0.

As illustrated in FIG. 2, the UE 115-a may be configured with ROs during both SBFD and non-SBFD time slots. For example, the UE 115-a may receive from the network entity 105-a control information 205 (e.g., RRC signaling) that configures the UE 115-a with a first set of ROs scheduled during SBFD slots (e.g., SBFD RO 215-a and 215-b) and a second set of ROs scheduled during non-SBFD slots (e.g., non-SBFD RO 210-a, 210-b, 210-c, and 210-d). Additionally, while FIG. 2 provides an example of the UE 115-a being configured with four non-SBFD ROs 210 and two SBFD ROs 215, it is understood the network entity 105-a may configure the UE 115-a with any first quantity of non-SBFD ROs 210 and any second quantity of SBFD ROs 215. In some examples, the UE 115-a may be configured as an SBFD-aware UE 115-a. As such, for random access operation for SBFD-aware UEs 115 in an RRC connected state, the SBFD-aware UEs 115 may operate in accordance with one or more RACH configurations.

In a first RACH configuration, the UE 115-a may operate in accordance with a single RACH configuration, where ROs scheduled within an uplink subband of an SBFD symbol (e.g., SBFD RO 215-a and 215-b) may be valid for PRACH preamble transmission by the UE 115-a. That is, the network entity 105-a may transmit as part of the control information 205 a single RACH configuration that includes both SBFD ROs 215 and non-SBFD ROs 210, where the UE 115-a may transmit PRACH preamble transmissions during the SBFD ROs 215 in accordance with being SBFD aware.

In a second RACH configuration, the UE 115-a may operate in accordance with two separate RACH configurations including a legacy RACH configuration that includes ROs scheduled during uplink slots (e.g., non-SBFD ROs 210) and an additional RACH configuration that includes ROs scheduled within an uplink subband of SBFD symbols (e.g., SBFD ROs 215). That is, the network entity 105-a may transmit as part of the control information 205 a first RACH configuration (e.g., a legacy RACH configuration) that includes the non-SBFD ROs 210 and a second RACH configuration (e.g., an additional RACH configuration) that includes SBFD ROs 215, where the UE 115-a may transmit PRACH preamble transmissions during the SBFD ROs 215 in accordance with being SBFD aware. In some examples, the first RACH configuration and the second RACH configuration may be associated with respective resources (e.g., respective RO time and frequency resources, respective power control configurations, or both). Additionally, or alternatively, first RACH configuration and the second RACH configuration may be associated with independent and respective SSB-RO mappings.

By transmitting PRACH preamble repetitions during SBFD ROs 215 in addition to non-SBFD ROs 210, the UE 115-a may increase the reliability and efficiency of PRACH preamble transmissions. For instance, in accordance with the example of FIG. 2, the non-SBFD ROs 210-a through 210-d may each be associated with a same RO group that is associated with a time duration 235. That is, the UE 115-a may be configured to transmit a respective repetition of a PRACH preamble during each of non-SBFD ROs 210-a through 210-d. In some cases, however, if a configured SBFD RO 215 is associated with a same preamble mapping as the non-SBFD ROs 210-a through 210-d and is scheduled after non-SBFD ROs 210-a and before non-SBFD ROs 210-d, the UE 115-a may use the configured SBFD RO 215 to transmit additional repetition of the PRACH preamble during the same time duration. Additionally, or alternatively, the UE 115-a may transmit in the configured SBFD RO 215 and drop a later scheduled non-SBFD RO 210, which may reduce latency.

As such, the UE 115-a may operate in accordance with one or more rules to determine which of the scheduled non-SBFD ROs 210 and SBFD ROs 215 to transmit repetitions of a PRACH preamble to increase PRACH reliability, decrease latency, or both. For example, the UE 115-a may perform RO validation procedure 220 to determine a set of consecutive valid ROs for transmission of a RACH message 230 (e.g., repetitions of a PRACH preamble), where the set of consecutive valid ROs include one or more of the non-SBFD ROs 210, one or more of the SBFD ROs 215, or both. Additionally, or alternatively, the UE 115-a may determine the set of consecutive valid ROs in accordance with a rule that defines how the SBFD ROs 215 are used for transmission of RACH repetitions.

In a first example of RO validation procedure 220, the UE 115-a may determine the group of ROs for PRACH repetition based on ROs within TDD symbols (e.g., non-SBFD ROs 210) in accordance with legacy UE PRACH transmission techniques. For instance, the UE 115-a (e.g., which is SBFD-aware) may consider valid ROs exclusively in non-SBFD symbols (TDD uplink or flexible symbols) to determine the set of consecutive ROs for PRACH repetition (e.g., only non-SBFD ROs 210). In such a first example, a length of the period for the set of consecutive ROs may be a multiple of an integer number associated with pattern periods (e.g., time duration 235).

In a second example of RO validation procedure 220, the UE 115-a may determine to use SBFD ROs 215 in addition to the non-SBFD ROs 210, if the SBFD ROs 215 are associated with a same preamble mapping as the non-SBFD ROs 210. In a first case of the second example, the UE 115-a transmits repetitions of the PRACH preamble via the SBFD ROs 215 in addition to the non-SBFD ROs 210. That is, the UE 115-a transmits a repetition of the PRACH preamble during non-SBFD RO 210-a through 210-d and additionally transmits a repetition of the PRACH preamble during SBFD RO 215-a and 215-b based on SBFD RO 215-a and 215-b residing within the time duration 235.

In a second case of the second example, the UE 115-a transmits a same quantity of PRACH repetitions as the quantity of non-SBFD ROs 210 included in the RO legacy group (e.g., four ROs), but over a period less than the time duration 235. That is, the UE 115-a may transmit a respective PRACH preamble repetition over non-SBFD RO 210-a, non-SBFD RO 210-b, SBFD RO 215-a, and non-SBFD RO 210-c and refrain from transmitting over SBFD RO 215-b and non-SBFD RO 210-d to reduce the latency associated with the RACH procedure.

In a third case of the second example, the UE 115-a may transmit a greater quantity of PRACH repetitions than the quantity of non-SBFD ROs 210 in the RO legacy group (e.g., more than four repetitions), but over a period less than the time duration 235. That is, the UE 115-a may transmit a respective PRACH preamble repetition over non-SBFD RO 210-a, non-SBFD RO 210-b, SBFD RO 215-a, non-SBFD RO 210-c, and SBFD RO 215-b and refrain from transmitting over non-SBFD RO 210-d to both increase the reliability and reduce the latency associated with the RACH procedure.

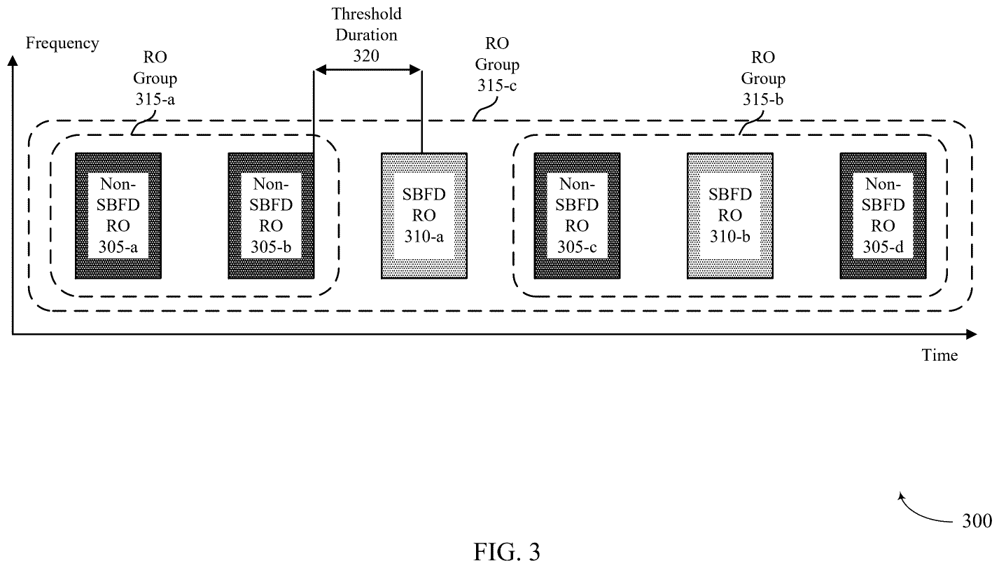

In a third example of RO validation procedure 220, the UE 115-a may transmit SBFD ROs 215 for opportunistic PRACH repetition if a given SBFD RO 215 temporally resides between a first and last legacy RO of a confirmed legacy RO group. That is, in the example of FIG. 2, an SBFD RO 215 that is after non-SBFD RO 210-a and before non-SBFD RO 210-d. Further discussion of the third example of RO validation procedure 220 is described herein, including with reference to FIG. 3.

In a fourth example of RO validation procedure 220, the UE 115-a may transmit SBFD ROs 215 for opportunistic PRACH repetition if a given SBFD RO 215 is within threshold duration of time after the last RO of a legacy RO group. That is, in the example of FIG. 2, an SBFD RO 215 that is within a threshold duration after non-SBFD RO 210-d. In some examples, the UE 115-a may receive a threshold duration indication 225 (e.g., a system information block 1 (SIB1) or RRC signaling) that may indicate the threshold duration. Further discussion of the fourth example of RO validation procedure 220 is described herein, including with reference to FIG. 3.

In a fifth example of RO validation procedure 220, if the PRACH latency associated with transmitting the PRACH preamble does not increase as the UE 115-a increases the quantity of repetitions (e.g., is less than or equal to time duration 235) the UE 115-a may select opportunistic SBFD ROs 215 within the time duration 235 for transmission of additional repetition of the PRACH preamble. If, however, the PRACH latency would be increased (e.g., result in a duration greater than time duration 235), the UE 115-a may operate in accordance with opportunistic ROs or use a larger RO legacy group size that is associated with an increased time duration 235. Further discussion of the fifth example of RO validation procedure 220 is described herein, including with reference to FIG. 3.

Additionally, while the first through fifth examples of RO validation procedure 220 are discussed as independent examples, it is understood the UE 115-a may combine and operate in accordance with rules from any of the first through fifth examples of RO validation procedure 220.

FIG. 3 shows an example of a RO validation procedure 300 that supports opportunistic multiple RACH transmissions using ROs in SBFD slots in accordance with one or more aspects of the present disclosure. The RO validation procedure 300 may implement or may be implemented by aspects of the wireless communications system 100 and 200. For example, the RO validation procedure 300 may be an example of RO validation procedure 220 performed by a UE 115, as described with reference to FIG. 2. For instance, RO validation procedure 300 may at least describe aspects associated with the third example, the fourth example, and the fifth example of RO validation procedure 220, as described in FIG. 2. Additionally, non-SBFD ROs 305 and SBFD ROs 310 may be respective examples of non-SBFD ROs 210 and SBFD ROs 215, as described in FIG. 2.

As illustrated in FIG. 3, the UE 115 may be configured with a set of non-SBFD ROs 305 (e.g., non-SBFD RO 305-a, 305-b, 305-c, and 305-d) and configured with a set of SBFD ROs 310 (e.g., SBFD RO 310-a and 310-d). Additionally, while FIG. 3 provides an example of the UE 115 being configured with four non-SBFD ROs 305 and two SBFD ROs 310, it is understood that a network entity 105 may configure the UE 115 with any first quantity of non-SBFD ROs 305 and any second quantity of SBFD ROs 310.

In some examples, the non-SBFD ROs 305 may be associated with one or more RO groups 315 (e.g., a legacy RO group that includes non-SBFD ROs 305). In some examples, FIG. 3 may describe examples according to two RO groups 315, where non-SBFD RO 305-a and 305-b are included in an RO group 315-a and non-SBFD RO 305-c and 305-d are included in an RO group 315-b (e.g., two legacy ROs in two respective legacy RO groups 315). Additionally, or alternatively, FIG. 3 may describe examples of RO group 315-c that includes non-SBFD RO 305-a, 305-b, 305-c, and 305-c (e.g., four legacy ROs in a single legacy RO group 315).

In accordance with RO validation procedure 300, the UE 115 may operate in accordance with one or more rules to determine whether the UE 115 may use one or more SBFD ROs 310 for opportunistic PRACH preamble repetition transmissions.

In some examples, the UE 115 may use SBFD-aware ROs (e.g., SBFD ROS 310) for opportunistic PRACH preamble repetition if the SBFD-aware ROs fall between the first and last legacy PRACH occasion of a legacy RO group 315. For instance, in examples where non-SBFD RO 305-a and 305-b are included in an RO group 315-a and non-SBFD RO 305-c and 305-d are included in an RO group 315-b, the UE 115 may transmit an additional repetition of a PRACH preamble during SBFD RO 310-b based on SBFD RO 310-b being temporarily after non-SBFD RO 305-c and before non-SBFD RO 305-d, and the UE 115 may refrain from transmitting during the SBFD RO 310-a based on SBFD RO 310-a not temporality residing within RO group 315-a or 315-b. In examples where non-SBFD RO 305-a through 305-d are included in RO group 315-c, the UE 115 may transmit an additional repetition of a PRACH preamble during SBFD RO 310-a and 315-b based on SBFD RO 310-a and 315-b being temporally after non-SBFD RO 305-a and before non-SBFD RO 305-d. By operating in accordance with such techniques, the UE 115 may opportunistically transmit additional repetitions of the PRACH preamble while not increasing latency associated with a given legacy RO group 315.

In some examples, the UE 115 may use SBFD-aware ROs (e.g., SBFD ROS 310) for opportunistic PRACH preamble repetition if the SBFD-aware ROs satisfy a threshold duration 320 after a last legacy RO of an RO group 315. For instance, in examples where non-SBFD RO 305-a and 305-b are included in an RO group 315-a, the UE 115 may transmit an additional repetition of a PRACH preamble during SBFD RO 310-a based on SBFD RO 310-a being within the threshold duration 320 after non-SBFD RO 305-b. In some examples, the threshold duration 320 may be a fixed value (e.g., x symbols or slots within the last legacy RO of an RO group 315). In some examples, the UE 115 may receive an indication of the threshold duration 320 via threshold duration indication 225, as described with reference to FIG. 2 (e.g., via SIB 1 or RRC signaling). By operating in accordance with such techniques, the UE 115 may opportunistically transmit additional repetitions of the PRACH preamble while incurring an increase in latency within a latency tolerance threshold.

In some examples of RO validation procedure 300, the UE 115 may be configured with a multiple legacy RO group sizes to transmit PRACH preamble repetitions in accordance with. For instance, the UE 115 may be configured to transmit in accordance a legacy RO group size of 2, 4, 8, 16, etc. Additionally, the UE 115 may determine to reduce the repetitions of PRACH preamble transmission based on an a measured SSB reference signal reserved power (RSRP). For instance, if the UE 115 measures (e.g., via reference signals received from the network entity 105) that the SSB RSRP associated with the SSB for a PRACH transmission is above a threshold, the UE 115 may determine to transmit in accordance with RO group 315-a and refrain from transmitting during RO group 315-b, to reduce signal overhead during instances of higher signal quality. In some cases, however, the UE 115 may still determine during cases of higher signal quality to transmit additional PRACH preamble repetitions over opportunistic SBFD-ROs. For instance, the UE 115 may determine to transmit during SBFD RO 310-a in addition to non-SBFD RO 305-a and 305-b of legacy RO group 315-a. However, by additionally transmitting during SBFD RO 310-a, the UE 115 may increase the quantity of PRACH transmissions closer to the next RO group size (e.g., a group size of four ROs rather than a group size of two ROs). As such, it may be advantageous for the UE 115 to determine whether to transmit PRACH preamble repetitions during two legacy ROs, during two legacy ROs and during two opportunistic SBFD ROs, or during four legacy ROs associated with a larger legacy group size.

If the UE 115 can refrain from increasing PRACH latency by selecting opportunistic ROs within the legacy group time duration, the UE 115 may increase the number of repetitions. For instance, in the example of FIG. 3, if the UE 115 determines to transmit repetitions of the PRACH preamble over RO group 315-b (e.g., during non-SBFD RO 305-c and 305-d) the UE 115 may opportunistically transmit an additional repetition of the PRACH preamble during SBFD RO 310-b, based on the additional repetition not increasing the PRACH latency associated with RO group 315-b.

In some other examples, however, selecting opportunistic ROs may increase the latency above the legacy group time duration. For instance, in the example of FIG. 3, if the UE 115 determines to transmit repetitions of the PRACH preamble over RO group 315-a (e.g., during non-SBFD RO 305-a and 305-b) and further determines to transmit an additional repetition of the PRACH preamble during SBFD RO 310-a, then the latency associated with the PRACH transmission may be greater compared to the latency associated with RO group 315-a. In such examples, the UE 115 may still determine to transmit additional repetitions of the PRACH preamble during opportunistic ROs (e.g., transmit during SBFD RO 310-a). In some other examples of determining a latency increase, the UE 115 may determine to use a larger legacy group size. For instance, in the example of FIG. 3, the UE 115 may determine to use RO group 315-c instead of RO group 315-a, where RO group 315-c is associated with an increase in tolerance for latency based on spanning a greater time duration compared to RO group 315-a.

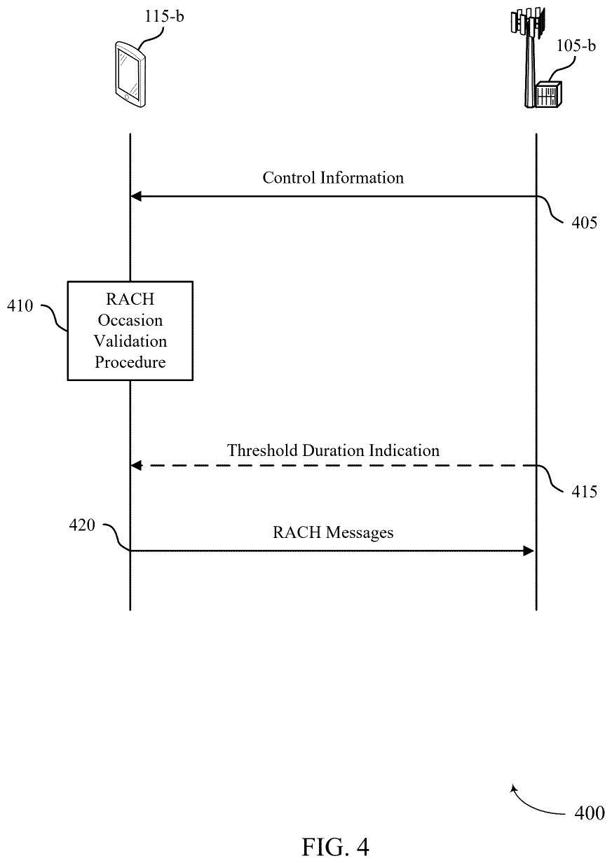

FIG. 4 shows an example of a process flow 400 that supports opportunistic multiple RACH transmissions using ROs in SBFD slots in accordance with one or more aspects of the present disclosure. In some examples, process flow 400 may implement aspects of wireless communications system 100, wireless communications system 200, and RO validation procedure 300. Process flow 400 may include a UE 115-b and a network entity 105-b, as described with reference to FIGS. 1 through 3. Alternative examples of the following may be implemented, where some steps are performed in a different order than described or are not performed at all. In some cases, steps may include additional features not mentioned below, or further steps may be added. In addition, it is understood that these processes may occur between any quantity of network devices and network device types.

At 405, the UE 115-b may receive from the network entity 105-b control information (e.g., control information 205, as described with reference to FIG. 2). For example, the UE 115-b may receive control information that indicates a first set of ROs scheduled during SBFD slots (e.g., SBFD ROs 215 or 310, as described with reference to FIGS. 2 and 3) and a second set of ROs scheduled during non-SBFD slots (e.g., non-SBFD ROs 210 or 305, as described with reference to FIGS. 2 and 3).

At 410, the UE 115-b may perform an RO validation procedure (e.g., RO validation procedure 220 or 300 as described with reference to FIGS. 2 and 3). For example, the UE 115-b may determine a set of consecutive valid ROs for transmission of a RACH message (e.g., RACH message 230, as described with reference to FIG. 2). In some examples, the set of consecutive valid ROs includes one or more of the set of SBFD ROs, one or more of the set of non-SBFD ROs, or both. In some examples, the set of consecutive valid ROs may be determined through the RO validation procedure in accordance with a rule that defines how the set of SBFD ROs may be used for transmission of RACH repetitions.

In some examples, the UE 115-b may determine the set of consecutive valid ROs through the RO validation procedure based on a configured quantity of RACH repetitions that each use a same frequency resource, where a rule-based time duration of the set of consecutive valid ROs may be based on a legacy time duration that includes the configured quantity of RACH repetitions associated with only the set of non-SBFD ROs.

In some examples, the set of consecutive valid ROs includes one or more of the set of non-SBFD ROs and does not include any of the first set ROs based on the rule defining that the set of consecutive valid ROs may be selected from only the set of non-SBFD ROS.

In some examples, the set of consecutive valid ROs includes one or more of the set of SBFD ROs and one or more of the set of non-SBFD ROs based on the rule defining that the set of consecutive valid ROs may be selected from individual ones of the set of SBFD ROs that are associated with a same preamble mapping as individual ones of the set of non-SBFD ROs. Additionally, or alternatively, the rule-based time duration of the set of consecutive valid ROs may be equal to the legacy time duration, where an actual quantity of the set of consecutive valid ROs may be greater than the configured quantity of RACH repetitions. Additionally, or alternatively, the rule-based time duration of the set of consecutive valid ROs may be less than the legacy time duration, where an actual quantity of the set of consecutive valid ROs may be equal to the configured quantity of RACH repetitions. Additionally, or alternatively, the rule-based time duration of the set of consecutive valid ROs may be less than the legacy time duration, where an actual quantity of the set of consecutive valid ROs may be greater than the configured quantity of RACH repetitions.

In some examples, the set of consecutive valid ROs includes one or more of the set of SBFD ROs and one or more of the set of non-SBFD ROs based on the rule defining that the set of consecutive valid ROs includes individual ones of the set of SBFD ROs only if the individual ones of the set of SBFD ROs are temporally after a starting RO of the set of non-SBFD ROs and before a last RO of the set of non-SBFD ROs during the legacy time duration.

In some examples, the set of consecutive valid ROs includes one or more of the set of SBFD ROs and one or more of the set of non-SBFD ROs based on the rule defining that the set of consecutive valid ROs includes individual ones of the set of SBFD ROs that are within a threshold quantity of symbols or slots after a last RO of the set of non-SBFD ROs during the legacy time duration (e.g., threshold duration 320, as described with reference to FIG. 3).

In some examples, the set of consecutive valid ROs includes one or more of the set of non-SBFD ROs and does not include any of the set of SBFD ROs based on the rule defining that the set of consecutive valid ROs may be selected from only the set of non-SBFD ROs as long as a first latency threshold is satisfied, where an actual quantity of the set of consecutive valid ROs may be equal to or greater than the configured quantity of RACH repetitions.

In some examples, the set of consecutive valid ROs includes one or more of the set of SBFD ROs and one or more of the set of non-SBFD ROs based on the rule defining that the set of consecutive valid ROs may be selected from both the set of SBFD ROs and the set of non-SBFD ROs if selection from only the set of non-SBFD ROs results in a first latency threshold not being satisfied, where an actual quantity of the set of consecutive valid ROs may be equal to or greater than the configured quantity of RACH repetitions.

In some examples, the set of consecutive valid ROs includes one or more of the set of non-SBFD ROs and does not include any of the set of SBFD ROs based on the rule defining that the set of consecutive valid ROs may be selected from only the set of non-SBFD ROs and that an actual quantity of the set of consecutive valid ROs may be greater than the configured quantity of RACH repetitions if selection from only the set of non-SBFD ROs for only the configured quantity of RACH repetitions results in a first latency threshold not being satisfied.

At 415, the UE 115-b may optionally receive a control message that indicates the threshold quantity of symbols or slots (e.g., threshold duration indication 225, as described with reference to FIG. 2).

At 420, the UE 115-b may transmit, to the network entity 105-b over the set of consecutive valid ROs, repetitions of the RACH message in accordance with the RO validation procedure.

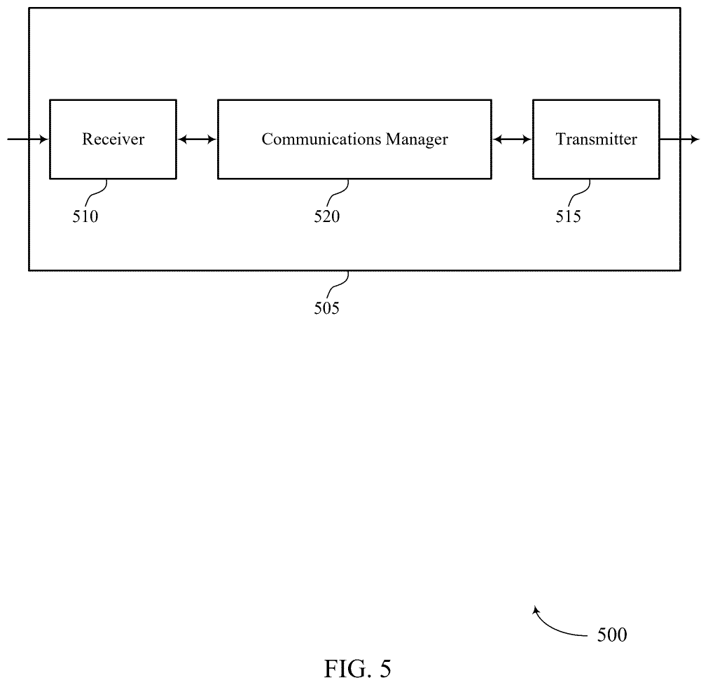

FIG. 5 shows a block diagram 500 of a device 505 that supports opportunistic multiple RACH transmissions using ROs in SBFD slots in accordance with one or more aspects of the present disclosure. The device 505 may be an example of aspects of a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to, individually or collectively, support or enable the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to opportunistic multiple RACH transmissions using ROs in SBFD slots). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to opportunistic multiple RACH transmissions using ROs in SBFD slots). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations or components thereof may be examples of means for performing various aspects of opportunistic multiple RACH transmissions using ROs in SBFD slots as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor (e.g., referred to as a processor-executable code). If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. For example, the communications manager 520 is capable of, configured to, or operable to support a means for receiving control information that indicates a first set of ROs scheduled during SBFD slots and a second set of ROs scheduled during non SBFD slots. The communications manager 520 is capable of, configured to, or operable to support a means for performing a RO validation procedure to determine a set of consecutive valid ROs for transmission of a RACH message, where the set of consecutive valid ROs includes one or more of the first set of ROs, one or more of the second set of ROs, or both, and where the set of consecutive valid ROs is determined through the RO validation procedure in accordance with a rule that defines how the first set of ROs is used for transmission of RACH repetitions. The communications manager 520 is capable of, configured to, or operable to support a means for transmitting, over the set of consecutive valid ROs, repetitions of the RACH message in accordance with the RO validation procedure.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for reduced processing, reduced power consumption, more efficient utilization of communication resources.

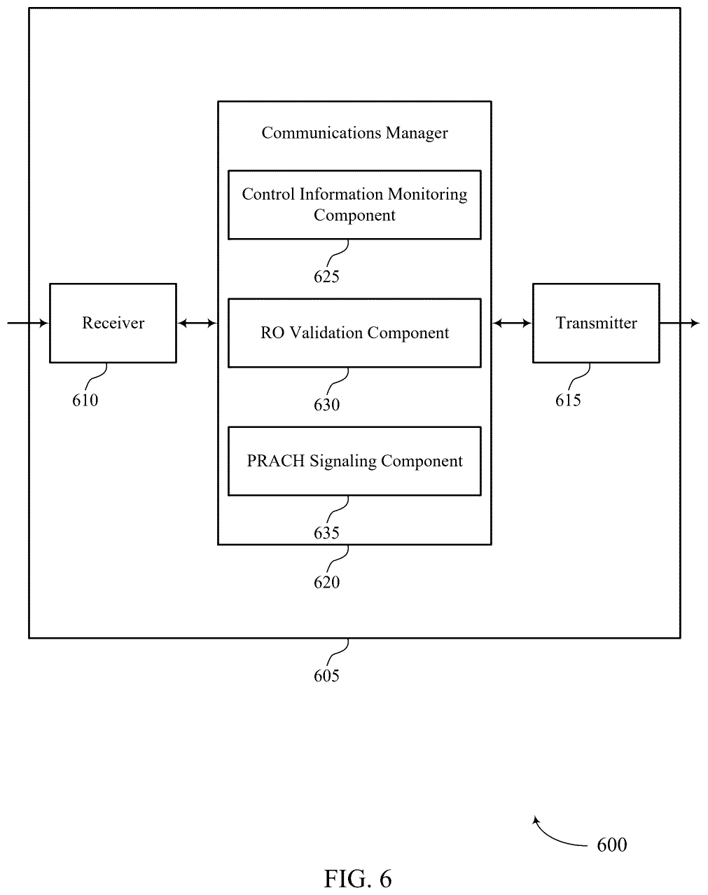

FIG. 6 shows a block diagram 600 of a device 605 that supports opportunistic multiple RACH transmissions using ROs in SBFD slots in accordance with one or more aspects of the present disclosure. The device 605 may be an example of aspects of a device 505 or a UE 115 as described herein. The device 605 may include a receiver 610, a transmitter 615, and a communications manager 620. The device 605, or one of more components of the device 605 (e.g., the receiver 610, the transmitter 615, the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to opportunistic multiple RACH transmissions using ROs in SBFD slots). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to opportunistic multiple RACH transmissions using ROs in SBFD slots). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of opportunistic multiple RACH transmissions using ROs in SBFD slots as described herein. For example, the communications manager 620 may include a control information monitoring component 625, a RO validation component 630, a PRACH signaling component 635, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. The control information monitoring component 625 is capable of, configured to, or operable to support a means for receiving control information that indicates a first set of ROs scheduled during SBFD slots and a second set of ROs scheduled during non SBFD slots. The RO validation component 630 is capable of, configured to, or operable to support a means for performing a RO validation procedure to determine a set of consecutive valid ROs for transmission of a RACH message, where the set of consecutive valid ROs includes one or more of the first set of ROs, one or more of the second set of ROs, or both, and where the set of consecutive valid ROs is determined through the RO validation procedure in accordance with a rule that defines how the first set of ROs is used for transmission of RACH repetitions. The PRACH signaling component 635 is capable of, configured to, or operable to support a means for transmitting, over the set of consecutive valid ROs, repetitions of the RACH message in accordance with the RO validation procedure.

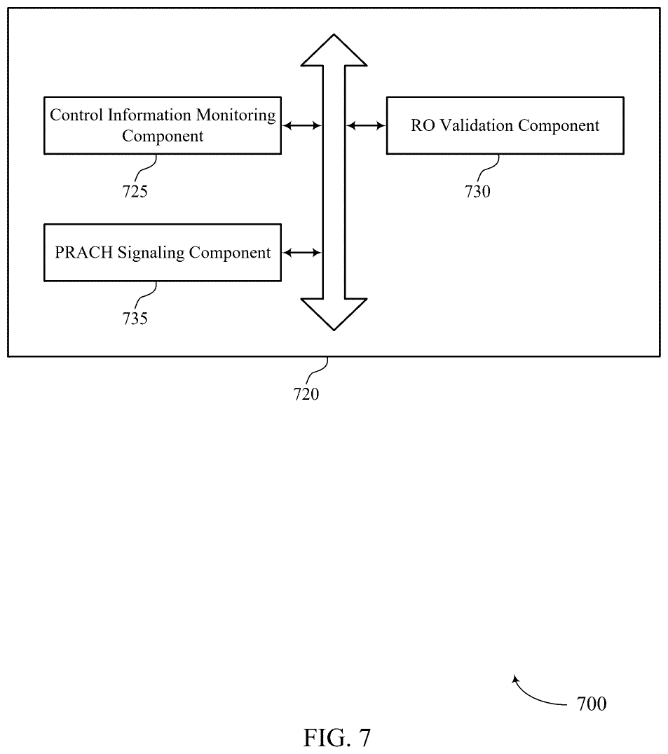

FIG. 7 shows a block diagram 700 of a communications manager 720 that supports opportunistic multiple RACH transmissions using ROs in SBFD slots in accordance with one or more aspects of the present disclosure. The communications manager 720 may be an example of aspects of a communications manager 520, a communications manager 620, or both, as described herein. The communications manager 720, or various components thereof, may be an example of means for performing various aspects of opportunistic multiple RACH transmissions using ROs in SBFD slots as described herein. For example, the communications manager 720 may include a control information monitoring component 725, a RO validation component 730, a PRACH signaling component 735, or any combination thereof. Each of these components, or components or subcomponents thereof (e.g., one or more processors, one or more memories), may communicate, directly or indirectly, with one another (e.g., via one or more buses).

The communications manager 720 may support wireless communications in accordance with examples as disclosed herein. The control information monitoring component 725 is capable of, configured to, or operable to support a means for receiving control information that indicates a first set of ROs scheduled during SBFD slots and a second set of ROs scheduled during non SBFD slots. The RO validation component 730 is capable of, configured to, or operable to support a means for performing a RO validation procedure to determine a set of consecutive valid ROs for transmission of a RACH message, where the set of consecutive valid ROs includes one or more of the first set of ROs, one or more of the second set of ROs, or both, and where the set of consecutive valid ROs is determined through the RO validation procedure in accordance with a rule that defines how the first set of ROs is used for transmission of RACH repetitions. The PRACH signaling component 735 is capable of, configured to, or operable to support a means for transmitting, over the set of consecutive valid ROs, repetitions of the RACH message in accordance with the RO validation procedure.

In some examples, the set of consecutive valid ROs is determined through the RO validation procedure based on a configured quantity of RACH repetitions that each use a same frequency resource. In some examples, a rule-based time duration of the set of consecutive valid ROs is based on a legacy time duration that includes the configured quantity of RACH repetitions associated with only the second set of ROs.

In some examples, the set of consecutive valid ROs includes one or more of the second set of ROs and does not include any of the first set ROs based on the rule defining that the set of consecutive valid ROs is selected from only the second set of ROs.

In some examples, the set of consecutive valid ROs includes one or more of the first set of ROs and one or more of the second set of ROs based on the rule defining that the set of consecutive valid ROs is selected from individual ones of the first set of ROs that are associated with a same preamble mapping as individual ones of the second set of ROs.

In some examples, the rule-based time duration of the set of consecutive valid ROs is equal to the legacy time duration. In some examples, an actual quantity of the set of consecutive valid ROs is greater than the configured quantity of RACH repetitions.

In some examples, the rule-based time duration of the set of consecutive valid ROs is less than the legacy time duration. In some examples, an actual quantity of the set of consecutive valid ROs is equal to the configured quantity of RACH repetitions.

In some examples, the rule-based time duration of the set of consecutive valid ROs is less than the legacy time duration. In some examples, an actual quantity of the set of consecutive valid ROs is greater than the configured quantity of RACH repetitions.

In some examples, the set of consecutive valid ROs includes one or more of the first set of ROs and one or more of the second set of ROs based on the rule defining that the set of consecutive valid ROs includes individual ones of the first set of ROs only if the individual ones of the first set of ROs are temporally after a starting RO of the second set of ROs and before a last RO of the second set of ROs during the legacy time duration.

In some examples, the set of consecutive valid ROs includes one or more of the first set of ROs and one or more of the second set of ROs based on the rule defining that the set of consecutive valid ROs includes individual ones of the first set of ROs that are within a threshold quantity of symbols or slots after a last RO of the second set of ROs during the legacy time duration.

In some examples, the control information monitoring component 725 is capable of, configured to, or operable to support a means for receiving a control message that indicates the threshold quantity.

In some examples, the set of consecutive valid ROs includes one or more of the second set of ROs and does not include any of the first set of ROs based on the rule defining that the set of consecutive valid ROs is selected from only the second set of ROs as long as a first latency threshold is satisfied. In some examples, an actual quantity of the set of consecutive valid ROs is equal to or greater than the configured quantity of RACH repetitions.

In some examples, the set of consecutive valid ROs includes one or more of the first set of ROs and one or more of the second set of ROs based on the rule defining that the set of consecutive valid ROs is selected from both the first set of ROs and the second set of ROs if selection from only the second set of ROs results in a first latency threshold not being satisfied. In some examples, an actual quantity of the set of consecutive valid ROs is equal to or greater than the configured quantity of RACH repetitions.

In some examples, the set of consecutive valid ROs includes one or more of the second set of ROs and does not include any of the first set of ROs based on the rule defining that the set of consecutive valid ROs is selected from only the second set of ROs and that an actual quantity of the set of consecutive valid ROs is greater than the configured quantity of RACH repetitions if selection from only the second set of ROs for only the configured quantity of RACH repetitions results in a first latency threshold not being satisfied.

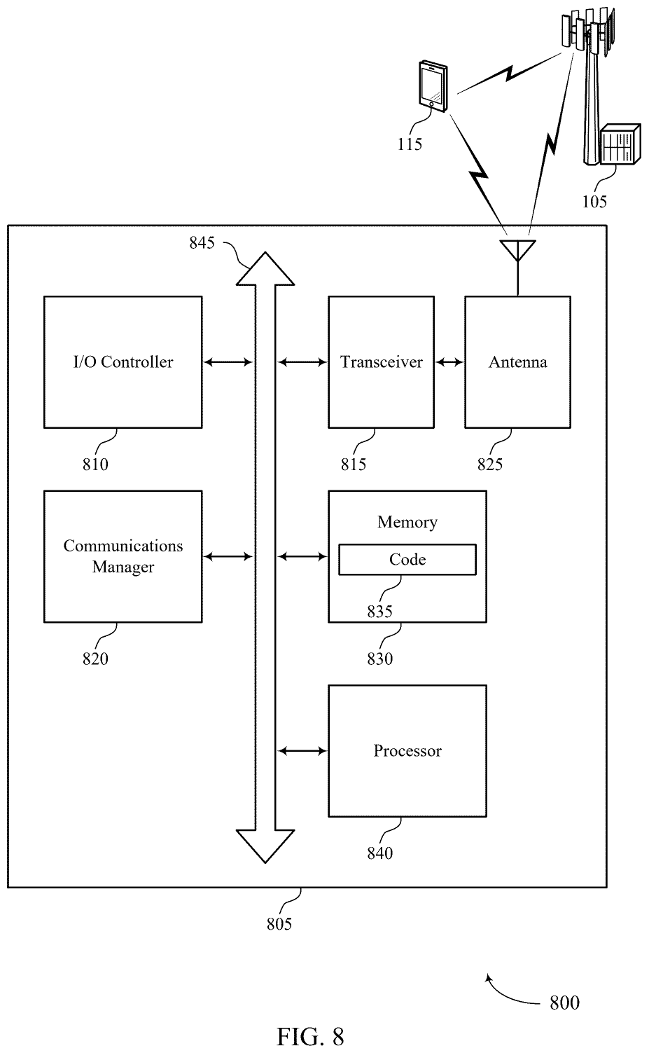

FIG. 8 shows a diagram of a system 800 including a device 805 that supports opportunistic multiple RACH transmissions using ROs in SBFD slots in accordance with one or more aspects of the present disclosure. The device 805 may be an example of or include components of a device 505, a device 605, or a UE 115 as described herein. The device 805 may communicate (e.g., wirelessly) with one or more other devices (e.g., network entities 105, UEs 115, or a combination thereof). The device 805 may include components for bi-directional voice and data communications including components for transmitting and receiving communications, such as a communications manager 820, an input/output (I/O) controller, such as an I/O controller 810, a transceiver 815, one or more antennas 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna. However, in some other cases, the device 805 may have more than one antenna, which may be capable of concurrently transmitting or receiving multiple wireless transmissions. The transceiver 815 may communicate bi-directionally via the one or more antennas 825 using wired or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include random access memory (RAM) and read-only memory (ROM). The at least one memory 830 may store computer-readable, computer-executable, or processor-executable code, such as the code 835. The code 835 may include instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (e.g., when compiled and executed) to perform functions described herein. In some cases, the at least one memory 830 may include, among other things, a basic I/O system (BIOS) which may control basic hardware or software operation such as the interaction with peripheral components or devices.

The at least one processor 840 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (e.g., the at least one memory 830) to cause the device 805 to perform various functions (e.g., functions or tasks supporting opportunistic multiple RACH transmissions using ROs in SBFD slots). For example, the device 805 or a component of the device 805 may include at least one processor 840 and at least one memory 830 coupled with or to the at least one processor 840, the at least one processor 840 and the at least one memory 830 configured to perform various functions described herein.

In some examples, the at least one processor 840 may include multiple processors and the at least one memory 830 may include multiple memories. One or more of the multiple processors may be coupled with one or more of the multiple memories, which may, individually or collectively, be configured to perform various functions described herein. In some examples, the at least one processor 840 may be a component of a processing system, which may refer to a system (such as a series) of machines, circuitry (including, for example, one or both of processor circuitry (which may include the at least one processor 840) and memory circuitry (which may include the at least one memory 830)), or components, that receives or obtains inputs and processes the inputs to produce, generate, or obtain a set of outputs. The processing system may be configured to perform one or more of the functions described herein. For example, the at least one processor 840 or a processing system including the at least one processor 840 may be configured to, configurable to, or operable to cause the device 805 to perform one or more of the functions described herein. Further, as described herein, being “configured to,” being “configurable to,” and being “operable to” may be used interchangeably and may be associated with a capability, when executing code 835 (e.g., processor-executable code) stored in the at least one memory 830 or otherwise, to perform one or more of the functions described herein.

The communications manager 820 may support wireless communications in accordance with examples as disclosed herein. For example, the communications manager 820 is capable of, configured to, or operable to support a means for receiving control information that indicates a first set of ROs scheduled during SBFD slots and a second set of ROs scheduled during non SBFD slots. The communications manager 820 is capable of, configured to, or operable to support a means for performing a RO validation procedure to determine a set of consecutive valid ROs for transmission of a RACH message, where the set of consecutive valid ROs includes one or more of the first set of ROs, one or more of the second set of ROs, or both, and where the set of consecutive valid ROs is determined through the RO validation procedure in accordance with a rule that defines how the first set of ROs is used for transmission of RACH repetitions. The communications manager 820 is capable of, configured to, or operable to support a means for transmitting, over the set of consecutive valid ROs, repetitions of the RACH message in accordance with the RO validation procedure.

By including or configuring the communications manager 820 in accordance with examples as described herein, the device 805 may support techniques for improved communication reliability, reduced latency, improved user experience related to reduced processing, reduced power consumption, more efficient utilization of communication resources, improved coordination between devices, longer battery life, and improved utilization of processing capability.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of opportunistic multiple RACH transmissions using ROs in SBFD slots as described herein, or the at least one processor 840 and the at least one memory 830 may be otherwise configured to, individually or collectively, perform or support such operations.

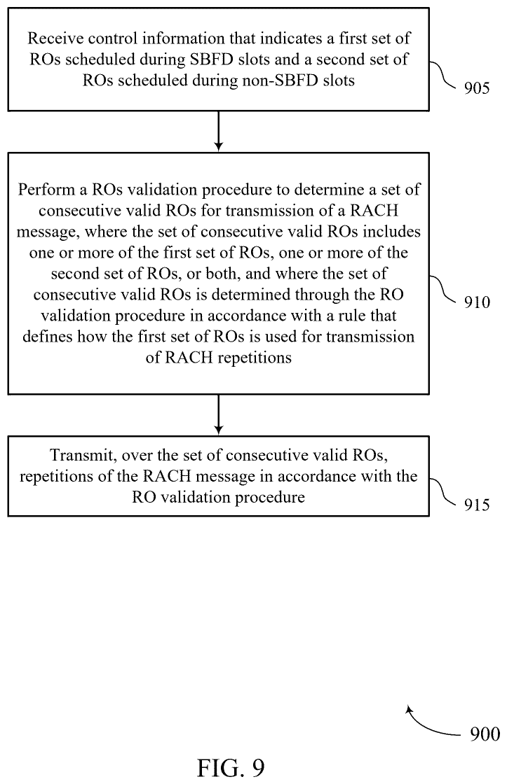

FIG. 9 shows a flowchart illustrating a method 900 that supports opportunistic multiple RACH transmissions using ROs in SBFD slots in accordance with one or more aspects of the present disclosure. The operations of the method 900 may be implemented by a UE or its components as described herein. For example, the operations of the method 900 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 905, the method may include receiving control information that indicates a first set of ROs scheduled during SBFD slots and a second set of ROs scheduled during non SBFD slots. The operations of 905 may be performed in accordance with examples as disclosed herein. In some examples, aspects of the operations of 905 may be performed by a control information monitoring component 725 as described with reference to FIG. 7.

At 910, the method may include performing a RO validation procedure to determine a set of consecutive valid ROs for transmission of a RACH message, where the set of consecutive valid ROs includes one or more of the first set of ROs, one or more of the second set of ROs, or both, and where the set of consecutive valid ROs is determined through the RO validation procedure in accordance with a rule that defines how the first set of ROs is used for transmission of RACH repetitions. The operations of 910 may be performed in accordance with examples as disclosed herein. In some examples, aspects of the operations of 910 may be performed by a RO validation component 730 as described with reference to FIG. 7.

At 915, the method may include transmitting, over the set of consecutive valid ROs, repetitions of the RACH message in accordance with the RO validation procedure. The operations of 915 may be performed in accordance with examples as disclosed herein. In some examples, aspects of the operations of 915 may be performed by a PRACH signaling component 735 as described with reference to FIG. 7.

The following provides an overview of aspects of the present disclosure:

Aspect 1: A method for wireless communications at a UE, comprising: receiving control information that indicates a first set of ROs scheduled during SBFD slots and a second set of ROs scheduled during non SBFD slots; performing a RO validation procedure to determine a set of consecutive valid ROs for transmission of a RACH message, wherein the set of consecutive valid ROs comprises one or more of the first set of ROs, one or more of the second set of ROs, or both, and wherein the set of consecutive valid ROs is determined through the RO validation procedure in accordance with a rule that defines how the first set of ROs is used for transmission of RACH repetitions; and transmitting, over the set of consecutive valid ROs, repetitions of the RACH message in accordance with the RO validation procedure.

Aspect 2: The method of aspect 1, wherein the set of consecutive valid ROs is determined through the RO validation procedure based on a configured quantity of RACH repetitions that each use a same frequency resource, a rule-based time duration of the set of consecutive valid ROs is based on a legacy time duration that includes the configured quantity of RACH repetitions associated with only the second set of ROs.

Aspect 3: The method of aspect 2, wherein the set of consecutive valid ROs comprises one or more of the second set of ROs and does not comprise any of the first set ROs based at least in part on the rule defining that the set of consecutive valid ROs is selected from only the second set of ROs.

Aspect 4: The method of any of aspects 2 through 3, wherein the set of consecutive valid ROs comprises one or more of the first set of ROs and one or more of the second set of ROs based at least in part on the rule defining that the set of consecutive valid ROs is selected from individual ones of the first set of ROs that are associated with a same preamble mapping as individual ones of the second set of ROs.

Aspect 5: The method of aspect 4, wherein the rule-based time duration of the set of consecutive valid ROs is equal to the legacy time duration, and an actual quantity of the set of consecutive valid ROs is greater than the configured quantity of RACH repetitions.

Aspect 6: The method of any of aspects 4 through 5, wherein the rule-based time duration of the set of consecutive valid ROs is less than the legacy time duration, and an actual quantity of the set of consecutive valid ROs is equal to the configured quantity of RACH repetitions.

Aspect 7: The method of any of aspects 4 through 6, wherein the rule-based time duration of the set of consecutive valid ROs is less than the legacy time duration, and an actual quantity of the set of consecutive valid ROs is greater than the configured quantity of RACH repetitions.

Aspect 8: The method of any of aspects 2 through 7, wherein the set of consecutive valid ROs comprises one or more of the first set of ROs and one or more of the second set of ROs based at least in part on the rule defining that the set of consecutive valid ROs includes individual ones of the first set of ROs only if the individual ones of the first set of ROs are temporally after a starting RO of the second set of ROs and before a last RO of the second set of ROs during the legacy time duration.

Aspect 9: The method of any of aspects 2 through 8, wherein the set of consecutive valid ROs comprises one or more of the first set of ROs and one or more of the second set of ROs based at least in part on the rule defining that the set of consecutive valid ROs includes individual ones of the first set of ROs that are within a threshold quantity of symbols or slots after a last RO of the second set of ROs during the legacy time duration.

Aspect 10: The method of aspect 9, further comprising: receiving a control message that indicates the threshold quantity.

Aspect 11: The method of any of aspects 2 through 10, wherein the set of consecutive valid ROs comprises one or more of the second set of ROs and does not comprise any of the first set of ROs based at least in part on the rule defining that the set of consecutive valid ROs is selected from only the second set of ROs as long as a first latency threshold is satisfied, an actual quantity of the set of consecutive valid ROs is equal to or greater than the configured quantity of RACH repetitions.

Aspect 12: The method of any of aspects 2 through 11, wherein the set of consecutive valid ROs comprises one or more of the first set of ROs and one or more of the second set of ROs based at least in part on the rule defining that the set of consecutive valid ROs is selected from both the first set of ROs and the second set of ROs if selection from only the second set of ROs results in a first latency threshold not being satisfied, an actual quantity of the set of consecutive valid ROs is equal to or greater than the configured quantity of RACH repetitions.

Aspect 13: The method of any of aspects 2 through 12, wherein the set of consecutive valid ROs comprises one or more of the second set of ROs and does not comprise any of the first set of ROs based at least in part on the rule defining that the set of consecutive valid ROs is selected from only the second set of ROs and that an actual quantity of the set of consecutive valid ROs is greater than the configured quantity of RACH repetitions if selection from only the second set of ROs for only the configured quantity of RACH repetitions results in a first latency threshold not being satisfied.

Aspect 14: A UE for wireless communications, comprising one or more memories storing processor-executable code, and one or more processors coupled with the one or more memories and individually or collectively operable to execute the code to cause the UE to perform a method of any of aspects 1 through 13.

Aspect 15: A UE for wireless communications, comprising at least one means for performing a method of any of aspects 1 through 13.

Aspect 16: A non-transitory computer-readable medium storing code for wireless communications, the code comprising instructions executable by one or more processors to perform a method of any of aspects 1 through 13.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive control information that indicates a first set of random access channel (RACH) occasions scheduled during subband full duplex slots and a second set of RACH occasions scheduled during non subband full duplex slots;
perform a RACH occasion validation procedure to determine a set of consecutive valid RACH occasions for transmission of a RACH message, wherein the set of consecutive valid RACH occasions comprises one or more of the first set of RACH occasions, one or more of the second set of RACH occasions, or both, and wherein the set of consecutive valid RACH occasions is determined through the RACH occasion validation procedure in accordance with a rule that defines how the first set of RACH occasions is used for transmission of RACH repetitions; and
transmit, over the set of consecutive valid RACH occasions, repetitions of the RACH message in accordance with the RACH occasion validation procedure.

2. The UE of claim 1, wherein the set of consecutive valid RACH occasions is determined through the RACH occasion validation procedure based on a configured quantity of RACH repetitions that each use a same frequency resource, and wherein a rule-based time duration of the set of consecutive valid RACH occasions is based on a legacy time duration that includes the configured quantity of RACH repetitions associated with only the second set of RACH occasions.

3. The UE of claim 2, wherein the set of consecutive valid RACH occasions comprises one or more of the second set of RACH occasions and does not comprise any of the first set RACH occasions based at least in part on the rule defining that the set of consecutive valid RACH occasions is selected from only the second set of RACH occasions.

4. The UE of claim 2, wherein the set of consecutive valid RACH occasions comprises one or more of the first set of RACH occasions and one or more of the second set of RACH occasions based at least in part on the rule defining that the set of consecutive valid RACH occasions is selected from individual ones of the first set of RACH occasions that are associated with a same preamble mapping as individual ones of the second set of RACH occasions.

5. The UE of claim 4, wherein the rule-based time duration of the set of consecutive valid RACH occasions is equal to the legacy time duration, and wherein an actual quantity of the set of consecutive valid RACH occasions is greater than the configured quantity of RACH repetitions.

6. The UE of claim 4, wherein the rule-based time duration of the set of consecutive valid RACH occasions is less than the legacy time duration, and wherein an actual quantity of the set of consecutive valid RACH occasions is equal to the configured quantity of RACH repetitions.

7. The UE of claim 4, wherein the rule-based time duration of the set of consecutive valid RACH occasions is less than the legacy time duration, and wherein an actual quantity of the set of consecutive valid RACH occasions is greater than the configured quantity of RACH repetitions.

8. The UE of claim 2, wherein the set of consecutive valid RACH occasions comprises one or more of the first set of RACH occasions and one or more of the second set of RACH occasions based at least in part on the rule defining that the set of consecutive valid RACH occasions includes individual ones of the first set of RACH occasions only if the individual ones of the first set of RACH occasions are temporally after a starting RACH occasion of the second set of RACH occasions and before a last RACH occasion of the second set of RACH occasions during the legacy time duration.

9. The UE of claim 2, wherein the set of consecutive valid RACH occasions comprises one or more of the first set of RACH occasions and one or more of the second set of RACH occasions based at least in part on the rule defining that the set of consecutive valid RACH occasions includes individual ones of the first set of RACH occasions that are within a threshold quantity of symbols or slots after a last RACH occasion of the second set of RACH occasions during the legacy time duration.

10. The UE of claim 9, wherein the one or more processors are individually or collectively further operable to execute the code to cause the UE to:
receive a control message that indicates the threshold quantity.

11. The UE of claim 2, wherein the set of consecutive valid RACH occasions comprises one or more of the second set of RACH occasions and does not comprise any of the first set of RACH occasions based at least in part on the rule defining that the set of consecutive valid RACH occasions is selected from only the second set of RACH occasions as long as a first latency threshold is satisfied, and wherein an actual quantity of the set of consecutive valid RACH occasions is equal to or greater than the configured quantity of RACH repetitions.

12. The UE of claim 2, wherein the set of consecutive valid RACH occasions comprises one or more of the first set of RACH occasions and one or more of the second set of RACH occasions based at least in part on the rule defining that the set of consecutive valid RACH occasions is selected from both the first set of RACH occasions and the second set of RACH occasions if selection from only the second set of RACH occasions results in a first latency threshold not being satisfied, and wherein an actual quantity of the set of consecutive valid RACH occasions is equal to or greater than the configured quantity of RACH repetitions.

13. The UE of claim 2, wherein the set of consecutive valid RACH occasions comprises one or more of the second set of RACH occasions and does not comprise any of the first set of RACH occasions based at least in part on the rule defining that the set of consecutive valid RACH occasions is selected from only the second set of RACH occasions and that an actual quantity of the set of consecutive valid RACH occasions is greater than the configured quantity of RACH repetitions if selection from only the second set of RACH occasions for only the configured quantity of RACH repetitions results in a first latency threshold not being satisfied.

14. A method for wireless communications at a user equipment (UE), comprising:
receiving control information that indicates a first set of random access channel (RACH) occasions scheduled during subband full duplex slots and a second set of RACH occasions scheduled during non subband full duplex slots;
performing a RACH occasion validation procedure to determine a set of consecutive valid RACH occasions for transmission of a RACH message, wherein the set of consecutive valid RACH occasions comprises one or more of the first set of RACH occasions, one or more of the second set of RACH occasions, or both, and wherein the set of consecutive valid RACH occasions is determined through the RACH occasion validation procedure in accordance with a rule that defines how the first set of RACH occasions is used for transmission of RACH repetitions; and
transmitting, over the set of consecutive valid RACH occasions, repetitions of the RACH message in accordance with the RACH occasion validation procedure.

15. The method of claim 14, wherein the set of consecutive valid RACH occasions is determined through the RACH occasion validation procedure based on a configured quantity of RACH repetitions that each use a same frequency resource, and wherein a rule-based time duration of the set of consecutive valid RACH occasions is based on a legacy time duration that includes the configured quantity of RACH repetitions associated with only the second set of RACH occasions.

16. The method of claim 15, wherein the set of consecutive valid RACH occasions comprises one or more of the second set of RACH occasions and does not comprise any of the first set RACH occasions based at least in part on the rule defining that the set of consecutive valid RACH occasions is selected from only the second set of RACH occasions.

17. The method of claim 15, wherein the set of consecutive valid RACH occasions comprises one or more of the first set of RACH occasions and one or more of the second set of RACH occasions based at least in part on the rule defining that the set of consecutive valid RACH occasions is selected from individual ones of the first set of RACH occasions that are associated with a same preamble mapping as individual ones of the second set of RACH occasions.

18. The method of claim 17, wherein the rule-based time duration of the set of consecutive valid RACH occasions is equal to the legacy time duration, and wherein an actual quantity of the set of consecutive valid RACH occasions is greater than the configured quantity of RACH repetitions.

19. The method of claim 17, wherein the rule-based time duration of the set of consecutive valid RACH occasions is less than the legacy time duration, and wherein an actual quantity of the set of consecutive valid RACH occasions is equal to the configured quantity of RACH repetitions.

20. A non-transitory computer-readable medium storing code for wireless communications, the code comprising instructions executable by one or more processors to:
receive control information that indicates a first set of random access channel (RACH) occasions scheduled during subband full duplex slots and a second set of RACH occasions scheduled during non subband full duplex slots;
perform a RACH occasion validation procedure to determine a set of consecutive valid RACH occasions for transmission of a RACH message, wherein the set of consecutive valid RACH occasions comprises one or more of the first set of RACH occasions, one or more of the second set of RACH occasions, or both, and wherein the set of consecutive valid RACH occasions is determined through the RACH occasion validation procedure in accordance with a rule that defines how the first set of RACH occasions is used for transmission of RACH repetitions; and
transmit, over the set of consecutive valid RACH occasions, repetitions of the RACH message in accordance with the RACH occasion validation procedure.
